(19) United States
(12) Patent Application Publication
(10) Pub. No.: US 2006/0251389 A1
(43) Pub. Date: Nov. 9, 2006

(54) Display apparatus and control method thereof

(75) Inventor: Dae-gu Kim, Gwacheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/407,073

(22) Filed: Apr. 20, 2006

(30) Foreign Application Priority Data
May 6, 2005 (KR) 2005-0038124

(51) Int. Cl. H04N 5/91

(52) U.S. Cl. 386/83

(57) ABSTRACT

The present invention relates to a display apparatus which includes a plurality of video signal input units to receive video signals from a plurality of video sources. The display apparatus includes a user input unit which has a plurality of keys to allow a user to select a channel; a video signal processing unit to process the video signal; a storage unit to store source number information corresponding to the respective video sources; and a control unit to control the video signal processing unit to process the video signal received from the video source corresponding to one of the source number information on the basis of combination of key inputs through the user input unit. Thus, the present invention provides a display apparatus and a control method thereof which allow a user to switch source modes in the same manner as used in switching broadcast channels through keys previously provided for switching channels.

### CROSS-REFERENCE TO RELATED APPLICATIONS

This application claims priority from Korean Patent Application No. 2005-0038124 filed May 6, 2005 in the Korean Intellectual Property Office, the disclosure of which is incorporated herein by reference.

### BACKGROUND OF THE INVENTION

1. Field of the Invention

Apparatuses and methods consistent with the present invention relate to a display apparatus and a control method thereof, and more particularly, to a display apparatus and a control method thereof which allow a user to switch a source mode in the same manner as used in switching a broadcast channel through keys previously provided for switching channels.

2. Description of the Related Art

In general, a display apparatus is provided with a video signal input unit to receive video signals from an external source, and processes the video signals inputted through the video signal input unit to be displayed on a display unit, thereby allowing a user to see a picture based on the video signals. As an example of the display apparatus, a television will be described hereinafter.

As technology has been developed, there is provided a television which includes a plurality of different video signal input units to be connected to various different external sources to receive various kinds of pictures from the external sources. The television can select a certain external source and reproduce a picture based on a video signal transmitted from the selected external source.

In a conventional television provided with the plurality of video signal input units, in order to select specific external source, a user accesses a predetermined external source selection menu and manipulates it to select a specific external source which he/she wants to reproduce. Thus, the television reproduces a picture based on the video signals provided from the selected external source.

However, the conventional television has problems in that a user should cumbersomely access an on screen display (OSD) menu whenever he/she wants to select a desired external source, which is inconvenient for a user who is unaccustomed to manipulation of the OSD menu. Thus, there has been proposed a television, which includes a toggle key as a separate switching key for switching the external sources, or a plurality of selection keys corresponding to the respective external sources. However, as the number of the external sources connectable to the television increases, there still remain problems in that more keys are required in proportion to the increased number of external sources where the plurality of selection keys are provided corresponding to the respective external sources, and the separate switching key should be pressed many times repeatedly to switch the external sources where the separate switching key is provided.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above. Accordingly, it is an aspect of the present invention to provide a display apparatus and a control method thereof which allow a user to switch a source mode in the same manner as used in switching a broadcast channel through keys previously provided for switching channels.

Additional aspects and/or advantages of the invention will be set forth in part in the description which follows and, in part, will be obvious from the description, or may be learned by practice of the invention.

The foregoing and/or other aspects of the present invention are achieved by providing a display apparatus comprising a plurality of video signal input units to receive video signals from a plurality of video sources, the display apparatus comprising a user input unit comprising a plurality of keys to allow a user to select a channel; a video signal processing unit to process the video signal; a storage unit to store source number information corresponding to respective video sources; and a control unit to control the video signal processing unit to process the video signal received from the video source corresponding to one of the source number information on the basis of combination of key inputs through the user input unit.

According to an aspect of the present invention, the storage unit stores channel number information corresponding to respective broadcast channels, and the source number information is different from the channel number information.

According to an aspect of the present invention, the plurality of video sources comprises at least one of a broadcasting base station, a digital versatile disk (DVD) player, a video player, a personal computer (PC), and a memory.

According to an aspect of the present invention, the plurality of video signal input units comprises an antenna to receive a broadcast signal, a player connection unit to receive a video signal from the video player or the DVD player, and a PC input unit to receive a video signal from the PC. The control unit switches a current source mode to another source mode corresponding to source number information on the basis of combination of the key inputs. The source mode may be one of a broadcast mode reproducing the broadcast signal, a player mode reproducing the video signal from the video player, and a PC mode reproducing the video signal from the PC.

According to an aspect of the present invention, the control unit controls the video signal processing unit to receive and reproduce the broadcast signal from the broadcast channel corresponding to selected channel number information when one of the channel number information is selected, and to switch a current source mode to another source mode corresponding to selected source number information when one of the source number information is selected, on the basis of combination of the key inputs.

According to an aspect of the present invention, the display apparatus further comprises an OSD generating unit to generate a source channel menu based on the source number information corresponding to the respective video sources, and a broadcast channel menu based on the channel number information corresponding to each broadcast channel. The control unit controls the OSD generating unit to display the broadcast channel menu for a predetermined period in correspondence to the reproducible broadcast channel to be switched to when a broadcast channel is switched, and to display the source channel menu for a predetermined period in correspondence to the source channel to be switched to when a source mode is switched.

According to an aspect of the present invention, the user input unit comprises a channel up key and a channel down key, and the control unit controls the video signal processing unit to change a broadcast mode to a source mode corresponding to source number information next to the source number information for the broadcast mode when the channel up key is input while the broadcast channel having the highest channel number information is reproduced in the broadcast mode. The control unit also controls the video signal processing unit to change a broadcast mode to a source mode corresponding to source number information previous to the source number information for the broadcast mode when the channel down key is input while the broadcast channel having the lowest channel number information is reproduced in the broadcast mode.

According to an aspect of the present invention, the control unit controls the video signal processing unit to sequentially switch a current source mode to a next/video source mode on the basis of the source number information when the channel up key is input in a source mode which is not the broadcast mode. The control unit also controls the video signal processing unit to sequentially switch a current source mode to a previous source mode on the basis of the source number information when the channel down key is input in a source mode which is not the broadcast mode.

According to an aspect of the present invention, the control unit controls the video signal processing unit to switch a current source mode to the broadcast mode and reproduce a broadcast channel corresponding to the lowest channel number information when the channel up key is input in a source mode corresponding to source number information previous to the source number information for the broadcast mode. The control unit also controls the video signal processing unit to switch a current source mode to the broadcast mode and reproduce a broadcast channel corresponding to the highest channel number information when the channel down key is input in a source mode corresponding to source number information next to the source number information for the broadcast mode.

The foregoing and/or other aspects of the present invention are achieved by providing a method of controlling a display apparatus comprising a plurality of video signal input units to receive video signals from a plurality of video sources, and a user input unit comprising a plurality of keys such as number keys, the method comprising storing source number information corresponding to respective video sources; determining whether one of the stored source number information corresponding to each video source is selected on the basis of the keys input through the user input unit; and reproducing the video signal input from the video source corresponding to the selected source number information when one of the stored source number information is selected.

According to an aspect of the present invention, the method further comprises storing channel number information corresponding to respective broadcast channels, wherein the source number information is different from the channel number information.

According to an aspect of the present invention, the storing the source number information comprises sensing the video signals input through the plurality of video signal input units; allocating number information unused for the channel number information to the respective video sources corresponding to the sensed video signals; and storing the unused number information as the source number information.

According to an aspect of the present invention, the storing the source number information comprises sensing whether at least one of the video sources is disconnected from the plurality of video signal input units; reallocating the number information unused for the channel number information to the respective video sources except the disconnected video source when at least one of the video sources is disconnected from the plurality of video signal input units; and storing the unused number information as the source number information.

According to an aspect of the present invention, the reproducing the video signal input from the video source corresponding to the selected source number information comprises switching a source mode for the video source corresponding to the source number information on the basis of the inputs of the key, among a broadcast mode reproducing the broadcast signal, a player mode reproducing the video signal from the video player, and a PC mode reproducing the video signal from the PC.

According to an aspect of the present invention, the user input unit comprises a channel up key and a channel down key. The method further comprises determining whether one of the channel up key and the channel down key is input; determining whether a current source mode is a broadcast mode when one of the channel up key and the channel down key is input; and sequentially switching a current source mode to a next source mode on the basis of the source number information when the channel up key is input in a source mode which is not the broadcast mode, and sequentially switching a current source mode to a previous source mode on the basis of the source number information when the channel down key is input in a source mode which is not the broadcast mode.

According to an aspect of the present invention, the broadcast mode is switched to a source mode corresponding to source number information next to the source number information for the broadcast mode when the channel up key is input while a broadcast channel having the highest channel number information is reproduced in the broadcast mode, and the broadcast mode is switched to a source mode corresponding to source number information previous to the source number information for the broadcast mode when the channel down key is input while a broadcast channel having the lowest channel number information is reproduced in the broadcast mode.

According to an aspect of the present invention, a current source mode is changed to the broadcast mode to reproduce a broadcast channel corresponding to the lowest channel number information when the channel up key is input in a source mode corresponding to source number information previous to the source number information for the broadcast mode, and a current source mode is changed to the broadcast mode to reproduce a broadcast channel corresponding to the highest channel number information when the channel down key is input in a source mode corresponding to source number information next to the source number information for the broadcast mode.

### BRIEF DESCRIPTION OF THE DRAWINGS

These and other aspects and advantages of the present invention will become apparent and more readily appreciated from the following description of exemplary embodiments, taken in conjunction with accompanying drawings of which:

FIG. 1 is a control block diagram of a display apparatus according to an exemplary embodiment of the present invention;

FIG. 2 shows a configuration of a key input unit of the display apparatus according to an exemplary embodiment of the present invention;

FIG. 3 is a control flowchart of switching a source mode corresponding to a key input in the display apparatus according to an exemplary embodiment of the present invention;

FIG. 4 is a control flowchart of operations caused by a channel up key and a channel down key in the display apparatus according to an exemplary embodiment of the present invention; and

FIG. 5 is a diagram illustrating a flow of switching a broadcast channel and a source mode corresponding to a channel up and a channel down key in the display apparatus according to an exemplary embodiment of the present invention.

### DETAILED DESCRIPTION OF THE EXEMPLARY EMBODIMENTS

Reference will now be made in detail to the exemplary embodiments of the present invention with reference to the accompanying drawings, wherein like reference numerals refer to like elements throughout. The exemplary embodiments are described below so as to explain the present invention by referring to the figures.

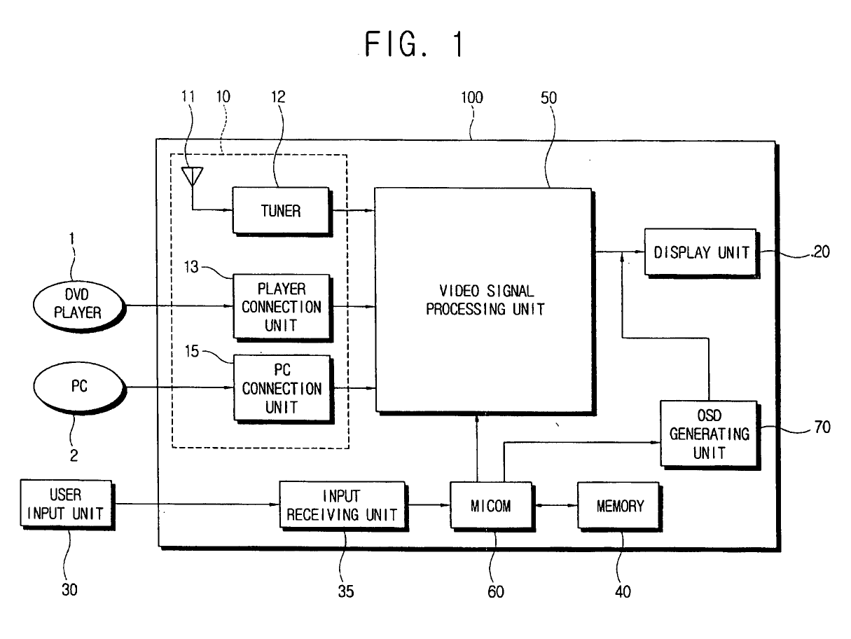

As shown in FIG. 1, a display apparatus 100 according to an exemplary embodiment of the present invention includes a display unit 20; a plurality of video signal input units 10 to receive various video signals from a plurality of video sources such as a broadcasting base station (not shown), a DVD player 1, and a PC 2; a video signal processing unit 50 to process the received video signal to be displayable on the display unit 20; a user input unit 30 to allow a user to select a key input; an input receiving unit 35 to receive a key input signal from the user input unit 30; a memory 40 used as storage means to store source number information corresponding to the respective video sources; and a microcomputer (MICOM) 60 used as a control unit to control the video signal processing unit 50 to process the video signal received from the video source corresponding to the source number information selected from the stored source number information on the basis of combination of the key inputs through the user input unit 30.

The display unit 20 receives the video signal from the video signal processing unit 50 and displays a picture based on the received video signal. The display unit 20 may include a display panel (not shown) to display a picture thereon, and a panel driver (not shown) to drive the display panel to display a picture based on the video signal processed by the video signal processing unit 50 thereon.

The plurality of video signal input units 10 receives various video signals from the plurality of video sources such as the broadcasting base station (not shown), the DVD player 1, and the PC 2. The plurality of video signal input units 10 may include at least one of an antenna 11 to receive broadcast signals provided from the broadcasting base station (not shown), a tuner 12 to select the broadcast signals received through the antenna 11, a player connection unit 13 to receive video signals from the DVD player 1, and a PC connection unit 15 to receive video signals from the PC 2. Here, the player connection unit 13 is configured to receive the video signals from the DVD player 1 by way of example, but not limited to it. Alternatively, the player connection unit 13 may be configured to be able to receive video signals from a video player such as a VCR (not shown).

The video signal processing unit 50 is a signal processor to process the video signal selected among received video signals under the control of the MICOM 60 to be displayed on the display unit 20. The video signal processing unit 50 may include a broadcast signal processing unit (not shown) to process video signals of the broadcast signal selected by the tuner 12, an analog to digital (A/D) converter (not shown) to convert video signals inputted through the player connection unit 13 or the PC connection unit 15 to digital video signals, and a scaler (not shown) to process the video signal outputted from one of the broadcast signal processing unit (not shown) and the A/D converter (not shown) to be displayable on the display unit 20. Below, the display apparatus 100 according to the present invention will be regarded as a digital television by way of example.

The broadcast signal processing unit (not shown) may include a channel decoder (not shown) to decode intermediate frequency (IF) broadcast signals of digital broadcast signals selected by the tuner 12 and output it as a specific transport stream, a TP decoder (not shown) to decode a specific video signal stream and program information of the corresponding channel switched by a user from the specific transport stream outputted from the channel decoder (not shown), and a video decoder (not shown) to receive and decompress the specific video signal stream outputted from the TP decoder (not shown), and reconstruct and output an original video signal to the scaler (not shown).

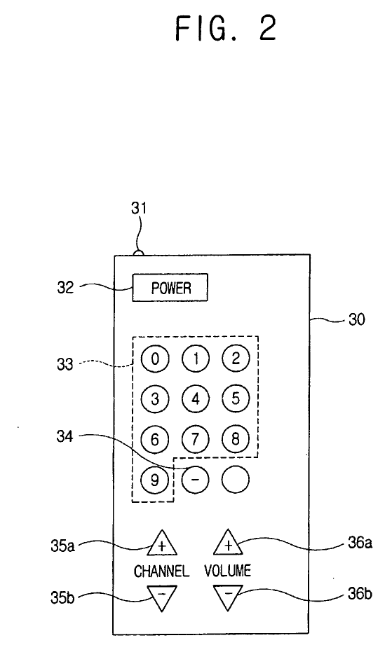

The user input unit 30 is an information input unit for allowing a user to select the key input, which can be directly provided in a main body of the display apparatus 100. Alternatively, the user input unit 30 can be provided as a remote controller for key manipulations of a user. In the embodiment shown in FIG. 1, the user input unit 30 is illustrated as the remote controller, and the main body of the display apparatus 100 is provided with the input receiving unit 35 to wirelessly receive a key input signal from the user input unit 30. Below, the user input unit 30 will be described in more detail with reference to FIG. 2.

The user input unit 30 includes a transmitter 31 to transmit wireless key input signals, a power key 32 to turn on/off the display apparatus 100, numeral keys 33 and a dash key 34 to select a broadcast channel in a broadcast mode, a channel up key 35a and a channel down key 35b to turn up/down the broadcast channel, and a volume up key 36a and a volume down key 36b to control volume up/down. Thus, when a user wants to select channel “11-3”, he/she presses twice a numeral key “1”, once the dash key 34, and then once numeral key “3” through the user input unit 30.

The memory 40 stores channel number information corresponding to each of the broadcast channels reproducible in broadcast mode and source number information corresponding to each of the video sources including the broadcast base station (not shown), the DVD player 1, and the PC 2. For example, the memory 40 stores the source number information and the channel number information as follows:

TABLE 1
Channel number information

| 3-0 | 6-1 | 11-0 | 11-1 | 11-2 |
|---|---|---|---|---|
| Signal 1 | Signal 3 | Signal 5 | Signal 6 | Signal 7 |

Source number information

| 0-1 | 0-2 | 0-3 |
|---|---|---|
| PC mode | Broadcast mode | Player mode |

The MICOM 60 controls the video signal processing unit 50 to process a video signal selected by a user from video signals inputted through the plurality of video signal input units 10 and to display a picture based on the processed video signal on the display unit 20. The MICOM 60 monitors whether the channel number information is inputted or the source number information is inputted, on the basis of the key input from the user input unit 30. When the source number information is inputted, the MICOM 60 controls the video signal processing unit 50 to process the video signal received from the video source corresponding to the inputted source number information. For example, when “0-1” is inputted, the MICOM 60 controls the video signal processing unit 50 to switch a current source mode to the PC mode on the basis of the information in Table 1. In the PC mode, the video signal provided from the PC 2 connected to PC connecting unit 15 is processed and reproduced.

When the channel number information is inputted, the MICOM 60 determines whether the current mode is the broadcast mode or not. In the case of the broadcast mode, the MICOM 60 controls the video signal processing unit 50 to process the video signal of the broadcast channel corresponding to the received channel number information on the basis of the information in Table 1. For example, when “6-1” is inputted, the MICOM 60 controls the video signal processing unit 50 to select and reproduce the broadcast channel corresponding to the “Signal 3”.

Like this, the display apparatus 100 according to an exemplary embodiment of the present invention allocates the video sources like respective further channels, using numeral information which is unused for the broadcast channels, i.e., numeral information different from the channel number information for the broadcast channel. Thus, by combination of the prepared numeral keys 33 and the dash key 34 without preparing a separate switching key to switch the video sources or respective selection keys to select the corresponding video sources, the display apparatus 100 can switch source modes in the same manner as used in switching broadcast channels.

The display apparatus 100 may further include an OSD generating unit 70 to generate a source channel menu based on the source number information corresponding to the respective video sources, e.g., the broadcast base station (not shown), the DVD player 1, and the PC 2, and a broadcast channel menu based on the channel number information corresponding to each broadcast channel.

Thus, the MICOM 60 controls the OSD generating unit 70 to display a broadcast channel menu (e.g., a channel “6-1”) for a predetermined period. Here, the broadcast channel menu to be displayed corresponds to a reproducible broadcast channel to be switched to when a broadcast channel is switched in response to the channel number information inputted through the user input unit 30 in broadcast mode. Further, the MICOM 60 controls the OSD generating unit 70 to display a source channel menu (e.g., a PC mode “0-1”) for a predetermined period. Here, the source channel menu to be displayed corresponds to the source channel to be switched to when a source mode is switched in response to the source number information inputted through the user input unit 30.

Therefore, the display apparatus 100 informs a user of whether the switching operation due to the currently generated key input is performed for switching channels or source modes, by means of the broadcast channel menu and the source channel menu. When the switching operation corresponds to the source mode switching, the display apparatus 100 informs the user of which source mode the current source mode is switched to, and what the source number information of the switched source mode is, thereby having an effect on preventing the user from being confused.

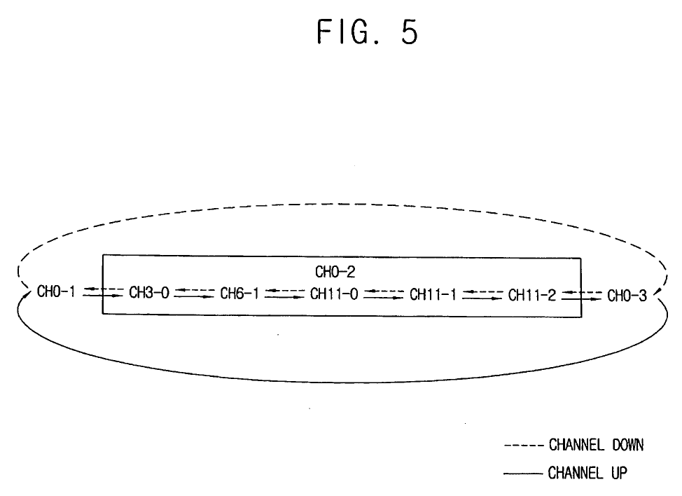

Further, when the channel up key 35a or the channel down key 35b is pressed, the MICOM 60 can control the video signal processing unit 50 to sequentially switch the broadcast channels or the source modes. Below, the operations of switching the broadcast channels and the source modes according to the inputs of the channel up key 35a and the channel down key 35b will be described with reference to FIG. 5.

Here, when the channel up key 35a is pressed, the MICOM 60 determines whether a current source mode is the broadcast mode. In the case where the current source mode is not the broadcast mode, the MICOM 60 controls the video signal processing unit 50 to change the current source mode (e.g., the PC mode having a source number information of “0-1”) to a next source mode (e.g., the broadcast mode having a source number information of “0-2”). As the current source mode is changed to the broadcast mode, the MICOM 60 controls the tuner 12 and the video signal processing unit 50 to reproduce broadcasting contents corresponding to the broadcast channel having the lowest number information of “3-0”. When the channel up key 35a is pressed in the broadcast mode, the MICOM 60 determines whether a current broadcasting channel is the broadcast channel having the highest number information of “11-2”. In the case where the current broadcasting channel is not the broadcast channel having the highest number information, the MICOM 60 performs a general function of the channel up key 35a and controls the tuner 12 and the video signal processing unit 50 to reproduce broadcasting contents corresponding to a broadcasting channel next to the current broadcasting channel. When the channel up key 35a is pressed in the broadcast mode to reproduce broadcasting contents corresponding to the broadcast channel having the highest number information of “11-2”, the MICOM 60 controls the video signal processing unit 50 to change the current source mode (i.e., the broadcast mode having source number information of “0-2”) to a next source mode (e.g., the DVD player mode having source number information of “0-3”).

Further, when the channel down key 35b is pressed, the MICOM 60 determines whether a current source mode is the broadcast mode. In the case where the current source mode is not the broadcast mode, the MICOM 60 controls the video signal processing unit 50 to change the current source mode (e.g., the PC mode having a source number information of “0-1”) to a previous source mode (e.g., the DVD mode having a source number information of “0-3”). Here, when the current source mode is changed to the broadcast mode in response to the input of the channel down key 35b, the MICOM 60 controls the tuner 12 and the video signal processing unit 50 to reproduce broadcasting contents corresponding to the broadcast channel having the highest number information of “11-2”. When the channel down key 35b is pressed in the broadcast mode, the MICOM 60 determines whether a current broadcasting channel is the broadcast channel having the lowest number information of “3-0”. When the current broadcasting channel is not the broadcast channel having the lowest number information, the MICOM 60 performs a general function of the channel down key 35b and controls the tuner 12 and the video signal processing unit 50 to reproduce broadcasting contents corresponding to the previous broadcasting channel to the current broadcasting channel. When the channel down key 35b is pressed in the broadcast mode to reproduce the broadcasting contents corresponding to the broadcast channel having the lowest number information of “3-0”, the MICOM 60 controls the video signal processing unit 50 to change the current source mode (i.e., the broadcast mode having a source number information of “0-2”) to a previous source mode (e.g., the PC mode having a source number information of “0-1”).

In other words, as shown in FIG. 5, the channel number information of the broadcast channels and the source number information of the source modes are recognized as one channel group, so that the switching operations are performed along a solid-line arrow in response to the input of the channel up key 35a, and performed along a dotted line arrow in response to the input of the channel down key 35b.

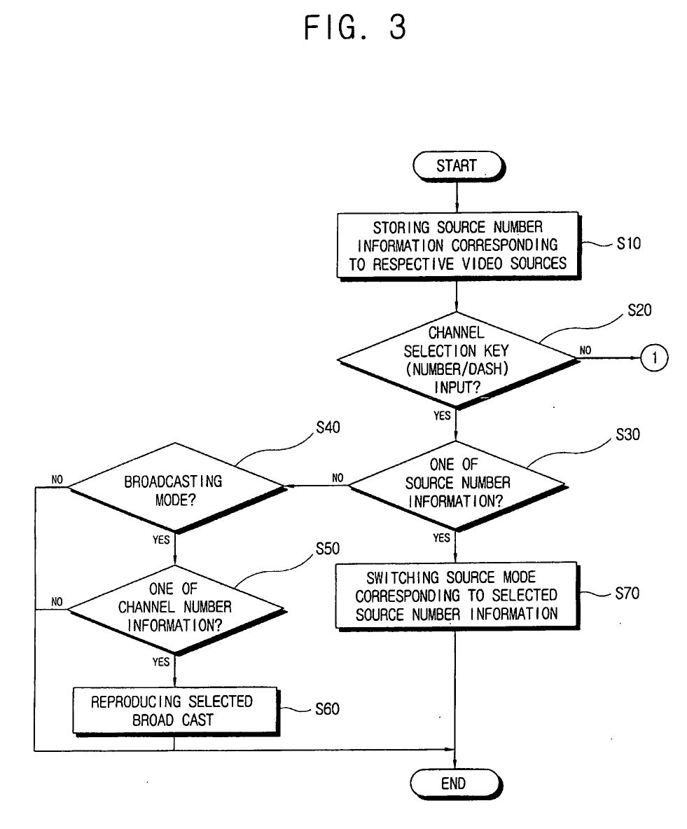

Referring to FIG. 3, a method of controlling the display apparatus 100 will be described as follows. First, at operation S10, numeral information “0-1”, “0-2” and “0-3” corresponding to respective video sources such as the PC 2, the broadcast base station (not shown), and the DVD player 1 is stored. For the sake of convenience, the numeral information “0-1”, “0-2” and “0-3” corresponding to the respective video sources will be referred to as the source number information hereinafter. It is apparent that channel number information corresponding to respective broadcast channels used for reproduction in the broadcast mode is also stored. Below, the operation S10 of storing the source number information will be described in more detail. In the operation S10 of storing the source number information, the MICOM 60 determines whether a video signal is input through the video signal input units 10, and controls the memory 40 to store the source number information “0-1”, “0-2” and “0-3” allocated to the respective video sources by using numeral information that is unused for the broadcast channels. Further, in the operation S10 of storing the source number information S10, the MICOM 60 determines whether at least one among the video sources connected to the plurality of video signal input units 10 is disconnected from the video signal input units 10. When at least one video source (e.g., the PC) is disconnected from the video signal input units 10, the MICOM 60 reallocates the numerals unused for the channel number information to the video sources except the disconnected video source (the PC), i.e., to the broadcast base station and the DVD player 1, respectively, and then controls the memory 40 to store the source number information “0-1” and “0-2”.

At operation S20, the MICOM 60 determines whether the numeral keys 33 and the dash key 34 are inputted through the user input unit 30. When the numeral keys 33 and the dash key 34 are inputted, at operation S30 the MICOM 60 determines whether the key input corresponds to one of the source number information. When the source number information is input, at operation S70 the MICOM 60 controls the video signal processing unit 50 to switch a current source mode to another source mode for reproducing a picture based on a video signal from the video source corresponding to the selected source number information. For example, when the source number information of “0-1” is input, the MICOM 60 controls the video signal processing unit 50 to switch a current source mode into the PC mode that processes a video signal transmitted from the PC 2 connected to the PC connection unit 15 and reproduces a picture based on the processed video signal.

In the operation S30, when the key input does not correspond to one of the source number information, at operation S40 the MICOM 60 determines whether the current source mode is the broadcast mode. When the current source mode is the broadcast mode, at operation S50 the MICOM 60 determines whether the key input corresponds to one of the channel number information. When the channel number information is input, at operation S60 the MICOM 60 recognizes the key input as general broadcast channel selection, and controls the video signal processing unit 50 to reproduce a picture based on the video signal of the broadcast channel corresponding to the received channel number information on the basis of the information in Table 1.

Thus, the display apparatus according to an exemplary embodiment of the present invention can switch source modes in the same manner as used in switching broadcast channels by combination of the prepared numeral keys 33 and the prepared dash key 34 without preparing a separate switching key to switch the video sources or respective selection keys to select the corresponding video sources.

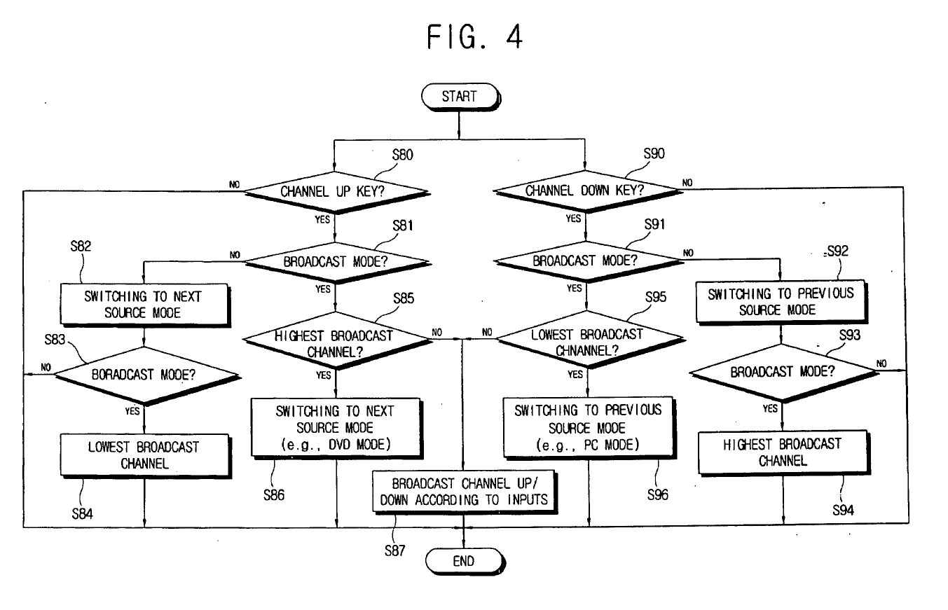

Further, when the numeral keys 33 and the dash key 34 are not input in the operation S20 (refer to \textcircled{1}), at operations S80 and S90 as shown in FIG. 4 the MICOM 60 determines whether the channel up key 35a or the channel down keys 35b is pressed.

When it is determined that the channel up key 35a is input in the operation S80, at operation S81 the MICOM 60 determines whether a current source mode is the broadcast mode. When the current source mode is not the broadcast mode, the MICOM 60 controls the video signal processing unit 50 to change the current source mode (e.g., the PC mode having a source number information of “0-1”) to a next source mode (e.g., the broadcast mode having a source number information of “0-2”). At operation S83, the MICOM 60 determines whether the current source mode is changed to the broadcast mode by the channel up key 35a. When the current source mode is changed to the broadcast mode by the channel up key 35a, at operation S84 the MICOM 60 controls the tuner 12 and the video signal processing unit 50 to reproduce broadcasting contents corresponding to the broadcast channel having the lowest number information of “3-0”. Further, when the channel up key 35a is pressed in the broadcast mode, at operation S85 the MICOM 60 determines whether the current broadcasting channel is the broadcast channel having the highest number information of “11-2”. In the case where the current broadcasting channel is not the broadcast channel having the highest number information, at operation S87 the MICOM 60 performs a general function of the channel up key 35a and controls the tuner 12 and the video signal processing unit 50 to reproduce broadcasting contents corresponding to the broadcasting channel next to the current broadcasting channel. When the channel up key 35a is pressed in the broadcast mode to reproduce broadcasting contents corresponding to the broadcast channel having the highest number information of “11-2”, at operation S86 the MICOM 60 controls the video signal processing unit 50 to change the current source mode (i.e., the broadcast mode having source number information of “0-2”) to a next source mode (e.g., the DVD player mode having source number information of “0-3”).

Further, when it is determined that the channel down key 35b is pressed in the operation S90, at operation S91 the MICOM 60 determines whether a current source mode is the broadcast mode. In the case where the current source mode is not the broadcast mode, at operation S92 the MICOM 60 controls the video signal processing unit 50 to change the current source mode (e.g., the PC mode having a source number information of “0-1”) to a previous source mode (e.g., the DVD mode having a source number information of “0-3”). At operation S93, the MICOM 60 determines whether the current mode is changed to the broadcast mode by the channel down key 35b. Here, when the source mode is changed to the broadcast mode in response to the input of the channel down key 35b, at operation S94 the MICOM 60 controls the tuner 12 and the video signal processing unit 50 to reproduce broadcasting contents corresponding to the broadcast channel having the highest number information of “11-2”. When the channel down key 35b is pressed in the broadcast mode, at operation S95 the MICOM 60 determines whether the current broadcasting channel is the broadcast channel having the lowest number information of “3-0”. When the current broadcasting channel is not the broadcast channel having the lowest number information, at operation S87 the MICOM 60 performs a general function of the channel down key 35b and controls the tuner 12 and the video signal processing unit 50 to reproduce broadcasting contents corresponding to the broadcasting channel previous to the current broadcasting channel. When the channel down key 35b is pressed in the broadcast mode to reproduce broadcasting contents corresponding to the broadcast channel having the lowest number information of “3-0”, at operation S96 the MICOM 60 controls the video signal processing unit 50 to change the current source mode (i.e., the broadcast mode having a source number information of “0-2”) to a previous source mode (e.g., the PC mode having a source number information of “0-1”).

Thus, the channel number information of the broadcast channels and the source number information of the source modes are recognized as one channel group, so that the source modes as well as the broadcast channels are switched by the inputs of the channel up key 35a and the channel down key 35b.

As described above, in the display apparatus 100 and the method of controlling the same according to an exemplary embodiment of present invention, the video sources are set to the respective further channels using numeral information which are unused for the broadcast channels, i.e., numeral information different from the channel number information for the broadcast channel. Thus, by combination of the prepared numeral keys 33 and the dash key 34 without preparing a separate switching key to switch the video sources or respective selection keys to select the corresponding video sources, the display apparatus 100 can switch source modes in the same manner as used in switching broadcast channels. Also, the channel number information of the broadcast channels and the source number information of the source modes are recognized as one channel group, so that broadcast channels and source modes are switched by the inputs of the channel up key 35a and the channel down key 35b.

As described above, the present invention provides a display apparatus and a control method thereof which allow a user to switch a source mode in the same manner as used in switching a broadcast channel through keys previously provided for switching channels.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
a plurality of video signal input units to receive video signals from a plurality of video sources;
a user input unit comprising a plurality of keys to allow a user to select a key input;
a video signal processing unit to process the received video signals;
a storage unit to store source number information corresponding to respective video sources; and
a control unit to control the video signal processing unit to process one of the received video signals corresponding to one of the source number information selected from the stored source number information on the basis of combination of key inputs through the user input unit.

2. The display apparatus according to claim 1, wherein the storage unit stores channel number information corresponding to respective broadcast channels, and
the source number information is different from the channel number information.

3. The display apparatus according to claim 2, wherein the plurality of video sources comprises at least one of a broadcasting base station, a digital versatile disk (DVD) player, a video player, a personal computer (PC), and a memory.

4. The display apparatus according to claim 3, wherein the plurality of video signal input units comprises at least one of an antenna to receive a broadcast signal, a player connection unit to receive a video signal from the video player or the DVD player, and a PC input unit to receive a video signal from the PC.

5. The display apparatus according to claim 4, wherein the video signal of each of the plurality of video sources is processed in a respective source mode by the video processing unit.

6. The display apparatus according to claim 5, wherein the respective source mode is one of a broadcast mode reproducing the broadcast signal, a player mode reproducing the video signal from the video player, and a PC mode reproducing the video signal from the PC.

7. The display apparatus according to claim 2, wherein the storage unit:
senses the video signals input through the plurality of video signal input units;
allocates numeral information unused for the channel number information to the respective video sources corresponding to the sensed video signals; and
and stores the unused numeral information as the source number information.

8. The display apparatus according to claim 7, wherein the storage unit:
senses whether at least one of the video sources is disconnected from the plurality of video signal input units;
reallocates the numeral information unused for the channel number information to the respective video sources except the disconnected video source when at least one of the video sources is disconnected from the plurality of video signal input units; and
stores the unused numeral information as the source number information.

9. The display apparatus according to claim 6, wherein the control unit controls the video signal processing unit to receive and reproduce the broadcast signal from the broadcast channel corresponding to selected channel number information when one of the channel number information is selected, and to switch a current source mode to another source mode corresponding to selected source number information when one of the source number information is selected.

10. The display apparatus according to claim 9, further comprising an on screen display (OSD) generating unit to generate selectively one of a source channel menu based on the source number information corresponding to the respective video sources and a broadcast channel menu based on the channel number information corresponding to each broadcast channel,
wherein the control unit controls the OSD generating unit to display the broadcast channel menu for a predetermined period in correspondence to a reproducible broadcast channel to be switched to when a broadcast channel is switched, and to display the source channel menu for a predetermined period in correspondence to a source channel to be switched to when a source mode is switched.

11. The display apparatus according to claim 9, wherein the user input unit comprises a channel up key and a channel down key;
the control unit controls the video signal processing unit to switch the broadcast mode to a source mode corresponding to source number information next to the source number information for the broadcast mode when the channel up key is input while a broadcast channel having the highest channel number information is reproduced in the broadcast mode; and
the control unit controls the video signal processing unit to switch the broadcast mode to a source mode of corresponding to source number information previous to the source number information for the broadcast mode when the channel down key is input while a broadcast channel having the lowest channel number information is reproduced in the broadcast mode.

12. The display apparatus according to claim 11, wherein the control unit controls the video signal processing unit to sequentially switch a current source mode to a next source mode on the basis of the source number information when the channel up key is input in a source mode which is not the broadcast mode; and
the control unit controls the video signal processing unit to sequentially switch a current source mode to a previous source mode on the basis of the source number information when the channel down key is input in a source mode which is not the broadcast mode.

13. The display apparatus according to claim 11, wherein the control unit controls the video signal processing unit to switch a current source mode to the broadcast mode and reproduce a broadcast channel corresponding to the lowest channel number information when the channel up key is input in a source mode corresponding to source number information previous to the source number information for the broadcast mode; and
the control unit controls the video signal processing unit to switch a current source mode to the broadcast mode and reproduce a broadcast channel corresponding to the highest channel number information when the channel down key is input in a source mode corresponding to source number information next to the source number information for the broadcast mode.

14. A method of controlling a display apparatus comprising a plurality of video signal input units to receive video signals from a plurality of video sources and a user input unit comprising a plurality of keys such as number keys, the method comprising:
storing source number information corresponding to respective video sources;
determining whether one of the stored source number information corresponding to each of the plurality of video sources is selected on the basis of combination of key inputs through the user input unit; and
reproducing one of the received video signals corresponding to one of the source number information selected from the stored source number information.

15. The method according to claim 14, further comprising storing channel number information corresponding to respective broadcast channels, wherein
the source number information is different from the channel number information.

16. The method according to claim 15, wherein the plurality of video sources comprises at least one of a broadcasting base station, a digital versatile disk (DVD) player, a video player, a personal computer (PC), and a memory.

17. The method according to claim 16, wherein the plurality of video signal input units comprises an antenna to receive a broadcast signal, a player connection unit to receive a video signal from the video player or the DVD player, and a PC input unit to receive a video signal from the PC.

18. The method according to claim 17, wherein the video signal of each of the plurality of video sources is processed in a respective source mode by the video signal processing unit.

19. The method according to claim 18, wherein the respective source mode is one of a broadcast mode reproducing the broadcast signal, a player mode reproducing the video signal from the video player, and a PC mode reproducing the video signal from the PC.

20. The method according to claim 15, wherein the storing the source number information comprises:
sensing the video signals input through the plurality of video signal input units;
allocating numeral information unused for the channel number information to the respective video sources corresponding to the sensed video signals; and
storing the unused numeral information as the source number information.

21. The method according to claim 20, wherein the storing the source number information comprises:
sensing whether at least one of the video sources is disconnected from the plurality of video signal input units;
reallocating the numeral information unused for the channel number information to the respective video sources except the disconnected video source when at least one of the video sources is disconnected from the plurality of video signal input units and
storing the unused numeral information as the source number information.

22. The method according to claim 19, wherein the reproducing the video signal input from the video source corresponding to the selected source number information comprises:
switching a current source mode to another source mode corresponding to selected source number information when one of the source number information is selected.

23. The method according to claim 22 comprising:
generating selectively one of a source channel menu using an OSD based on the source number information corresponding to the respective video sources and a broadcast channel menu based on the channel number information corresponding to each broadcast channel,
wherein the control unit controls the OSD generating unit to display the broadcast channel menu for a predetermined period in correspondence to a reproducible broadcast channel to be switched to when a broadcast channel is switched, and to display the source channel menu for a predetermined period in correspondence to a source channel to be switched to when a source mode is switched.

24. The method according to claim 22, wherein the user input unit comprises a channel up key and a channel down key, and
the method further comprising:
determining whether one of the channel up key and the channel down key is input;
determining whether a current source mode is a broadcast mode when one of the channel up key and the channel down key is input; and
sequentially switching a current source mode to a next source mode on the basis of the source number information when the channel up key is input in a source mode which is not the broadcast mode, and sequentially switching a current source mode to a previous source mode on the basis of the source number information when the channel down key is input in a source mode which is not the broadcast mode.

25. The method according to claim 24, wherein the broadcast mode is switched to a source mode corresponding to source number information next to the source number information for the broadcast mode when the channel up key is input while a broadcast channel having the highest channel number information is reproduced in the broadcast mode; and
the broadcast mode is switched to a source mode corresponding to source number information previous to the source number information for the broadcast mode when the channel down key is input while a broadcast channel having the lowest channel number information is reproduced in the broadcast mode.

26. The method according to claim 24, wherein a current source mode is changed to the broadcast mode to reproduce a broadcast channel corresponding to the lowest channel number information when the channel up key is input in a source mode corresponding to source number information previous to the source number information for the broadcast mode; and
a current source mode is changed to the broadcast mode to reproduce a broadcast channel corresponding to the highest channel number information when the channel down key is input in a source mode corresponding to source number information next to the source number information for the broadcast mode.
